(19) United States
(12) Patent Application Publication
(10) Pub. No.: US 2010/0035747 A1
(43) Pub. Date: Feb. 11, 2010

(54) PARTIALLY STABILIZED ZIRCONIA MATERIALS

(75) Inventors: Qiang Zhao, Natick, MA (US); Richard A. Gorski, Sterling, MA (US); Oh-Hun Kwon, Westborough, MA (US); Craig A. Willkens, Fort Wayne, IN (US)

Correspondence Address: LARSON NEWMAN & ABEL, LLP, 5914 WEST COURTYARD DRIVE, SUITE 200, AUSTIN, TX, 78730, US

(73) Assignee: Saint-Gobain Ceramics & Plastics, Inc., Worcester, MA (US)

(21) Appl. No.: 12/512,924

(22) Filed: Jul. 30, 2009

Related U.S. Application Data
(60) Provisional application No. 61/084,855, filed on Jul. 30, 2008.

(51) Int. Cl. C04B 35/48

(52) U.S. Cl. 501/134

(57) ABSTRACT

A ceramic material formed from a mixture including between about 50 wt % and about 85 wt % of a first zirconia-based material comprising between about 2 mol % and about 6 mol % yttria and between about 5 wt % and about 50 wt % of a second zirconia-based material comprising not greater than about 1 mol % yttria. The mixture can further include between about 1 wt % and about 10 wt % of an alumina material.

### CROSS-REFERENCE TO RELATED APPLICATIONS

The present application claims priority from U.S. Provisional Patent Application No. 61/084,855, filed Jul. 30, 2008, entitled “PARTIALLY STABILIZED ZIRCONIA MATERIALS HAVING AT LEAST TWO STABILIZING SPECIES AND METHODS OF FORMING THEREOF,” naming inventors Qiang Zhao, Richard A. Gorski, Oh-Hun Kwon and Craig A. Willkens, which application is incorporated by reference herein in its entirety.

### BACKGROUND

1. Field of the Disclosure

The present application is directed to partially stabilized zirconia materials, and more particularly to partially stabilized zirconia materials formed from two different types of zirconia-based materials, which may include two different zirconia materials having at least two stabilizing species.

2. Description of the Related Art

Toughened zirconia materials come in various forms, one of which includes partially stabilized zirconia (PSZ). A partially stabilized zirconia can be formed by the addition of a preferably minor amount of a stabilizer species, which can include other oxides, for example yttrium oxide (Y₂O₃), cerium oxide (CeO₂), magnesium oxide (MgO), or the like. Generally, PSZ materials are preferable in certain applications, such as wear-resistant coatings, since they can have higher mechanical strength and toughness than other traditional ceramic materials such as alumina.

Partially stabilized zirconia possesses a unique mechanism for improving the mechanical strength and toughness. That is, a stress-induced phase transformation from metastable tetragonal zirconia to stable monoclinic zirconia that can be further accompanied by a volume expansion to effectively prevent further crack propagation. However, it has been discovered that certain stabilized species have problems, for example, yttria stabilized zirconia has high strength, yet is susceptible to degradation of such properties at low temperatures (less than 400° C.). Other zirconia materials, such as magnesia stabilized zirconia materials, have superior toughness, yet lack the strength of other stabilized forms.

As such, the industry continues to demand improved materials having improved mechanical properties suitable for use in a wide variety of applications.

### SUMMARY

According to one aspect, a ceramic article includes a ceramic body including a partially stabilized zirconia material having a phase stabilizer. The phase stabilizer includes at least yttria and magnesia, wherein the mol % fraction of yttria/magnesia is not less than about 0.5. In certain other instances the mol % fraction of yttria/magnesia is not less than about 0.7, 1, or in some particular situations within a range between 1 and 10, 1 and 5, or even 1 and 3.

In accordance with another aspect, a ceramic article includes a ceramic body made of a partially stabilized zirconia material having a phase stabilizer material, the phase stabilizer material including at least two oxide stabilizer species. The partially stabilized zirconia ceramic body has a toughness (K1c) of not less than about 5.5 MPam^{1/2}. In such aspects, the toughness is measured by a indentation fracture technique.

According to another aspect, a ceramic article including a ceramic body comprising a stabilized zirconia material made from at least about 50 vol % of a yttria-containing zirconia powder, not greater than about 49 vol % of a magnesia-containing zirconia powder; and not greater than about 10 vol % of an alumina-containing powder.

In a fourth aspect, a method of forming a zirconia stabilized ceramic body includes mixing a yttria-containing zirconia powder and a magnesia-containing zirconia powder to form a mixture and forming the mixture into a green ceramic body. The method further includes sintering the green ceramic body to form a sintered ceramic body, and pressing the sintered ceramic body to form a partially stabilized zirconia ceramic body, wherein the mol % fraction ratio of yttria/magnesia within the ceramic body is not less than about 0.5.

According to another aspect a ceramic material is formed from a mixture comprising between about 60 wt % and about 85 wt % of a first zirconia-based material comprising between about 2 mol % and about 6 mol % yttria and between about 5 wt % and about 30 wt % of a second zirconia-based material comprising not greater than about 1 mol % yttria. The mixture can further include between about 1 wt % and about 10 wt % of an alumina material.

In yet another aspect, a ceramic material includes a partially stabilized zirconia ceramic body having a toughness (K1c) of not less than about 5.5 MPam^{1/2} as measured according to an indentation fracture method using a 10 Kg load, and a low temperature degradation factor of not greater than about 1% linear expansion after exposure to 69 psi of water at a temperature of 150° C. for 120 hours.

A ceramic material formed from a mixture including between about 50 wt % and about 85 wt % of a first zirconia-based material comprising between about 2 mol % and about 8 mol % yttria. The mixture further includes between about 15 wt % and about 50 wt % of a second zirconia-based material comprising not greater than about 1 mol % yttria.

### BRIEF DESCRIPTION OF THE DRAWINGS

The present disclosure may be better understood, and its numerous features and advantages made apparent to those skilled in the art by referencing the accompanying drawings.

FIG. 1 includes a flow chart illustrating a method of forming a ceramic body comprising partially stabilized zirconia in accordance with an embodiment.

FIG. 2 includes a scanning electron microscope (SEM) picture illustrating the microstructure of a ceramic body comprising partially stabilized zirconia in accordance with an embodiment.

FIG. 3 includes a SEM picture illustrating the microstructure of a conventional yttria-stabilized tetragonal zirconia ceramic body.

FIG. 4 includes a SEM picture illustrating the microstructure of a conventional magnesia-stabilized zirconia ceramic body.

FIG. 5 includes a flow chart illustrating a method of forming a ceramic body comprising partially stabilized zirconia in accordance with an embodiment.

FIG. 6 includes a SEM picture illustrating the microstructure of a ceramic body according to an embodiment.

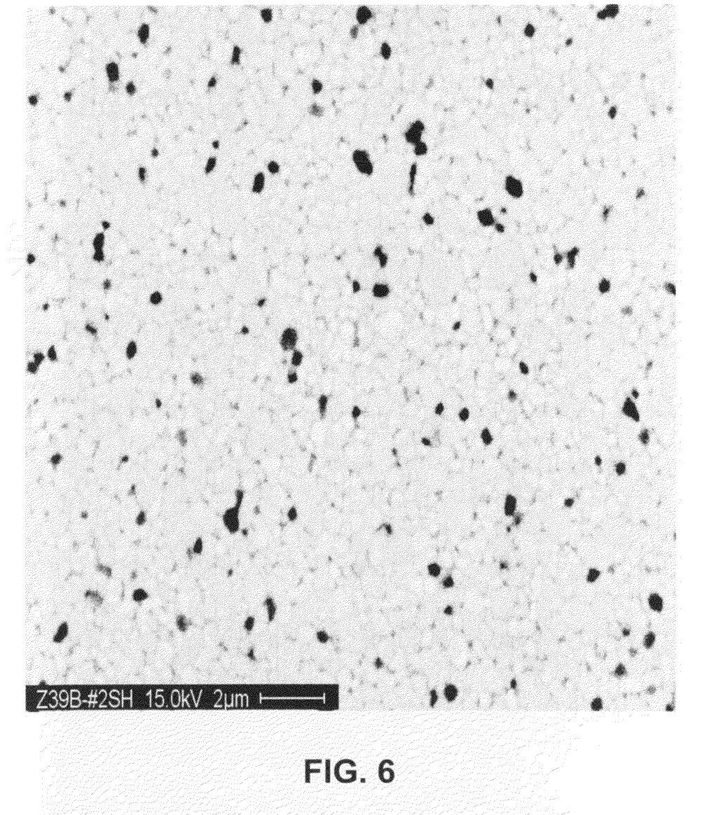

### DETAILED DESCRIPTION

The following disclosure is directed to partially stabilized zirconia (PSZ) materials containing a phase stabilizer. In certain cases, the ceramic material can be formed to include at least two stabilizing species, two of which include yttria and magnesia. Still, in other instances, the embodiments herein are directed to stabilized zirconia bodies using two distinct zirconia-based materials, which may include the use of a single stabilizing species (e.g., yttria). The following also discloses certain properties associated with such materials. Additionally, particular methods of forming such materials, particular examples, and comparative data illustrating differences between the presently disclosed PSZ materials and conventional materials is described herein.

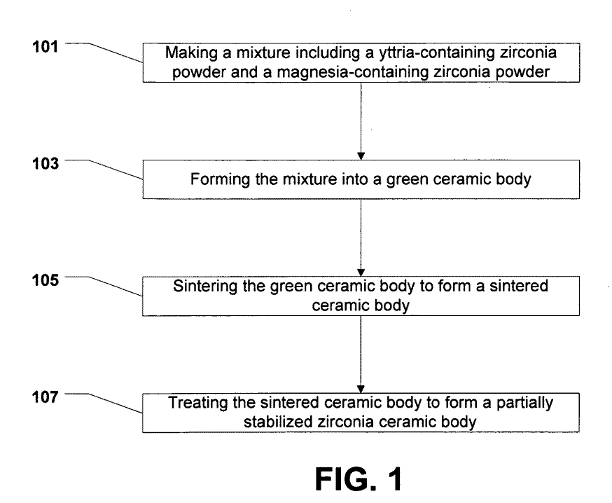

FIG. 1 illustrates a flowchart for forming a ceramic body comprising a partially stabilized zirconia including a phase stabilizer in accordance with one embodiment. The process is initiated at step 101 by making a mixture including a yttria-containing zirconia powder and a magnesia-containing zirconia powder, which facilitates the formation of a final-formed partially stabilized zirconia body using at least two phase stabilizing species (i.e., the yttria and magnesia). Generally, the formation of the mixture is such that the volume percent of the yttria-containing zirconia powder is equal to or greater than the volume percent of the magnesia-containing zirconia powder. As such, in one embodiment, the mixture contains not less than about 50 vol % of the yttria-containing zirconia powder. In accordance with other embodiments, the amount of yttria-containing zirconia powder can be greater, such as on the order of not less than about 60 vol %, 70 vol % or even not less than 75 vol %. In one particular embodiment, the mixture contains between about 70 vol % and about 95 vol % of the yttria-containing zirconia powder.

The amount of yttria within the yttria-containing zirconia powder is a minor amount, generally not exceeding about 10 mol % yttria. In some embodiments, the yttria-containing zirconia powder contains not greater than about 8 mol %, such as not greater than about 6 mol %, or even not greater than about 4 mol % yttria. In accordance with one particular embodiment, the yttria-containing zirconia powder contains between about 1 mol % and about 4 mol % yttria.

The amount of the magnesia-containing zirconia powder within the mixture is generally less, in terms of vol %, than that of the yttria-containing zirconia powder. For example, in one embodiment, the amount of magnesia-containing zirconia powder within the mixture is not greater than about 49 vol %. Still, in other embodiments the mixture may contain less, such that the powder contains not greater than about 40 vol %, 30 vol %, or even 25 vol % magnesia-containing zirconia powder. In accordance with one particular embodiment, the mixture contains between about 10 vol % and about 30 vol % of the magnesia-containing zirconia powder.

Like the yttria-containing powder, the magnesia-containing zirconia powder contains a minor amount of magnesia as compared to the amount of zirconia. For example, the magnesia-containing zirconia powder generally contains not greater than about 12 mol % magnesia. In fact, less magnesia can be used, such that the powder contains not greater than about 10 mol %, or even not greater than about 9 mol % magnesia. In one particular embodiment, the magnesia-containing zirconia powder contains between about 4 mol % and about 10 mol % magnesia.

Other characteristics of the yttria-containing powder and magnesia-containing powder are suited to the forming process and facilitate formation of a PSZ material as described herein. For example, with respect to the specific surface area of the powders, the yttria-containing zirconia powder can have a specific surface area that is at least about 3 m²/g. In fact, in other embodiments, the specific surface area can be greater, such as at least about 5 m²/g, at least about 8 m²/g, 10 m²/g, 15 m²/g, 20 m²/g, or even 30 m²/g. According to a particular embodiment, the yttria-containing zirconia powder can have a specific surface area within a range between about 5 m²/g and about 30 m²/g, and even more particularly within a range between about 10 m²/g and about 30 m²/g.

Likewise, the magnesia-containing zirconia powder can have a specific surface area that is at least about such as at least about 5 m²/g, at least about 8 m²/g, 10 m²/g, 15 m²/g, 20 m²/g, or even 30 m²/g. In certain instances, the magnesia-containing zirconia powder can have a specific surface area within a range between about 5 m²/g and about 30 m²/g, and even more particularly within a range between about 10 m²/g and about 30 m²/g.

The specific surface area of the magnesia-containing and yttria-containing zirconia powders can be increased by first conducting a milling operation on the powder. The increase surface area of the powders has been demonstrated to improve the reactability of the powders during the forming process and more particularly, the increased surface area of the powders have been observed to change certain mechanical properties, such as increasing the toughness of the final formed ceramic article.

In addition to the specific surface area values of these powders, the average particle size of the yttria-containing zirconia powder and magnesia-containing zirconia powder are such that they facilitate formation of a partially stabilized zirconia material having a fine-grained structure suitable for high strength mechanical applications. As such, in one particular embodiment, the yttria-containing zirconia powder has an average particle size of not greater than about 5 microns. Still, in other embodiments, this average particle size may be less, such as not greater than about 3 microns, not greater than about 2 microns, or even not greater than about 1 micron. In accordance with one particular embodiment, the yttria-containing zirconia powder has an average particle size within a range between about 0.01 microns and about 2.0 microns.

In some instances, the magnesia-containing zirconia powder can have an average particle size comparable to that of the yttria-containing zirconia powder. However, in certain embodiments, the magnesia-containing zirconia powder has an average particle size that is less than the average particle size of the yttria-containing zirconia powder. For example, the magnesia-containing zirconia powder can have an average particle size not greater than about 5 microns, 2 microns, and particularly within a range between about 0.01 microns and about 1.0 micron.

In addition to the yttria and magnesia phase stabilizer materials, other phase stabilizing species may be present. For example, other suitable phase stabilizer species can include elements such as Dy, In, Ca, Ce, Nd, and La. Certain embodiments may make use of other mixtures of phase stabilizers, including for example, a combination utilizing at least Dy and Mg, a combination using at least Y and In, Y and Ca, Dy and Ca, Dy and In, Ce and Ca, Nd and Ca, La and Ca, Ce and Mg, Nd and Mg, La and Mg, Ce and In, Nd and In, La and In, or the like, and any combination thereof.

In addition to the yttria-containing and magnesia-containing powders, the mixture can contain other components, for example other oxides. Such oxides, including for example alumina, can be added to the mixture separately, such as a separate powder material. In still other instances, other oxides, such as alumina, can be integrated within the zirconia powder materials, either the yttria-containing zirconia material, magnesia-containing powder, or both. In such instances, the oxide materials may not be added separately from the zirconia powders.

In one embodiment, the mixture can include a minor amount of an alumina-containing powder, which can lessen excess grain growth during forming. In certain embodiments, the mixture includes not greater than about 10 vol % of an alumina-containing powder, such as not greater than about 7 vol %, not greater than about 5 vol %, and more particularly within a range between about 1 vol % and 5 vol %.

The alumina-containing powder can include at least about 95% alumina. In other embodiments, the alumina-containing powder can be purer, such that it includes at least about 98% alumina, 99% alumina, or even 99.5% alumina. The balance of the alumina-containing powder may include other elements, compounds or impurities, such as metal oxides, which can be present in minor amounts. Typically, any of the other elements, compounds, or impurities are present in amounts on the order of parts a few per million or less.

As such, in accordance with one particular embodiment, the final mixture can include between about 70-80 vol % yttria-containing zirconia powder, between about 15-25 vol % magnesia-containing zirconia powder, and an amount of alumina-containing powder in a remainder amount in conditions where the total amount of yttria-containing and magnesia-containing powder is less than 100 vol %. For example, in one particular instance, the final mixture can include an amount of yttria-containing zirconia powder within a range between 75-80 vol %, between about 20-25 vol % magnesia-containing zirconia powder, and between 0-5 vol % alumina-containing powder.

The alumina-containing powder can have raw material characteristics suitable for forming a partially stabilized zirconia body having the characteristics and properties described herein. For example, it can have certain specific surface area and average primary particles sizes tailored to the process to facilitate the formation of the partially stabilized zirconia materials described herein. As such, in certain embodiments, the alumina-containing powder can have a specific surface area that is at least about 3 m²/g, at least about 5 m²/g, 10 m²/g, 15 m²/g, 20 m²/g, or even at least about 30 m²/g. According to a particular embodiment, the specific surface area of the alumina-containing powder is within a range between about 3 m²/g and about 30 m²/g.

The average particle size of the alumina-containing powder is generally micron size, such that in certain embodiments, it is not greater than about 5 microns. In certain other instances, the aluminum-containing powder can be sub-micron size such that the average particle size is within a range between about 0.01 microns, and about 1 micron.

After combining the proper amounts of the powder components, such materials may be mixed, such as by a dry mixing process or a wet mixing process. In accordance with one particular embodiment, mixing includes a wet mixing process, for example a ball milling process. That is, in certain instances the mixing procedure can include combining the mixture of raw materials of yttria-containing and magnesia-containing zirconia powders with an aqueous vehicle and a dispersant and milled.

According to a particular embodiment, the mixing process is a wet mixing process including forming a slurry using the dry powder mixture containing the yttria and magnesia-containing zirconia powders. The slurry can include at least about 50 wt % water, and more particularly at least about 50 wt % to about 65 wt % water. The slurry may further contain a dispersant, such as ammonium-containing material, for example, ammonium citrate.

Generally the mixing duration is at least 4 hours. In other embodiments, the mixing duration is longer, such as at least about 10 hours, at least about 12 hours, or even at least about 15 hours. According to a particular embodiment, the milling duration is within a range between about 10 hours and about 25 hours.

In such embodiments utilizing a wet mixing process, the slurry can be dried, which may depend in part upon the forming method. In certain instances, the drying process can be a spray drying process, wherein the slurry is extracted from the mixer or mill and additional materials can be added to facilitate the spray drying process. For example, in one embodiment, a binder material is added in a minor amount, such as on the order of less than about 5 wt % of the total slurry weight, to facilitate the formation of a spray dried binderized powder.

After suitably mixing the raw materials, the process continues at step 103 by forming the mixture into a green ceramic body. As used herein, the term “green ceramic body” is an unsintered body, such that it has not undergone sufficient heat treatment to effect full densification. Generally, forming of the green ceramic body can include various forming techniques such as molding, casting, or pressing depending upon the desired shape of the final-formed article and its intended application. However, in one particular instance, the forming process includes a pressing operation, such as a uniaxial, die-pressing operation or isostatic pressing operation. In some embodiments, the pressing operation can include a combination of forming techniques such as both uniaxial and isostatic pressing. According to one particular embodiment, the forming process includes uniaxially pressing the mixture to form a partially densified green ceramic body and subsequently conducting a cold isostatic pressing, which aids further densification of the green ceramic body.

After forming the green ceramic body, the process continues at step 105 by sintering the green ceramic body to form a sintered ceramic body. The sintering process includes sufficient heat treatment to effect substantial or even full densification of the green ceramic body. As such, in one particular embodiment, the sintering process is carried out at a sintering temperature of at least 1200° C., or even at least about 1300° C. According to one particular embodiment, the sintering temperature is within a range between about 1400° C. and 1600° C.

Sintering can be carried out for a duration of not less than about 20 minutes at the sintering temperature. In particular examples, the sintering duration can be extended, such that it is not less than about 30 minutes, not less than 40 minutes, or even not less than 60 minutes at the sintering temperature. In one particular embodiment, sintering is carried out for a duration within a range between about 20 minutes and about 240 minutes at the sintering temperature. Generally, the sintering operation is carried out in air. Moreover, sintering is typically carried out to close porosity within the ceramic body. For example, the sintering operation can be conducted to achieve a ceramic body having a density of at least about 90%, such as at least 95% dense based upon the theoretical density.

In addition to sintering at a particular temperature, the sintered ceramic body may be cooled down at a controlled rate such that the microstructure and, more particularly, certain crystalline phases of the sintered ceramic body are maintained. In particular, the cooling rate may differ between certain temperatures. For example the cooling rate from the sintering temperature to approximately 1200° C. is within a range between about 15° C./min and about 20° C./min. The cooling rate from 1200° C. to 1000° C. can be less, such as within a range between about 8° C./min and about 12° C./min. At temperatures from 1000° C. to 600° C. the rate of cooling can be within a range between 4° C./min and about 8° C./min.

After sintering at step 105, the process can continue at step 107 by treating the sintered ceramic body to form a partially stabilized zirconia ceramic body. The treating operation facilitates full densification of the final formed zirconia body and improved properties of the final-formed body. Treating can include additional heat treatment of the sintered ceramic body to effect full densification. In accordance with one particular embodiment, the treating operation includes a hot-isostatic-pressing (HIPing) operation. Together with sintering, such processing is known as sinter-HIPing, and accordingly, can be carried out at temperatures similar to those of the sintering temperature such that the PSZ material is exposed to an elevated temperature and pressure for a certain duration. For example, the HIPing operation can be conducted at a HIPing temperature of at least 1100° C., at least 1400° C., and more particularly, within a range between about 1100° C. and 1700° C. Typically, the atmosphere used during the HIPing operation is generally an inert atmosphere. For example, in one particular embodiment, the atmosphere comprises argon. It will be appreciated that the treating process does not necessarily include application of pressure to the ceramic body.

Furthermore, HIPing can be conducted at a particular pressure to effect full densification, using pressures on the order of at least about 130 MPa. In some certain embodiments, the HIPing pressure can be at least about 150 MPa, or at least about 200 MPa. In one particular embodiment, the HIPing pressure is within a range between about 150 MPa and about 275 MPa.

In accordance with another embodiment, the HIPing operation is conducted such that the sintered body is held at pressure and temperature for a duration of at least about 20 minutes. Other embodiments may utilize longer times, such as at least 40 minutes or at least about 60 minutes. Certain embodiments call for a duration within a range between about 20 minutes and about 120 minutes.

After conducting the process illustrated in FIG. 1, a final-formed ceramic body made of a PSZ material is obtained. The ceramic body has superior density, such that it is at least about 95% dense, more particularly at least about 98% dense, and in some embodiments, at least about 99% dense based upon theoretical density calculations.

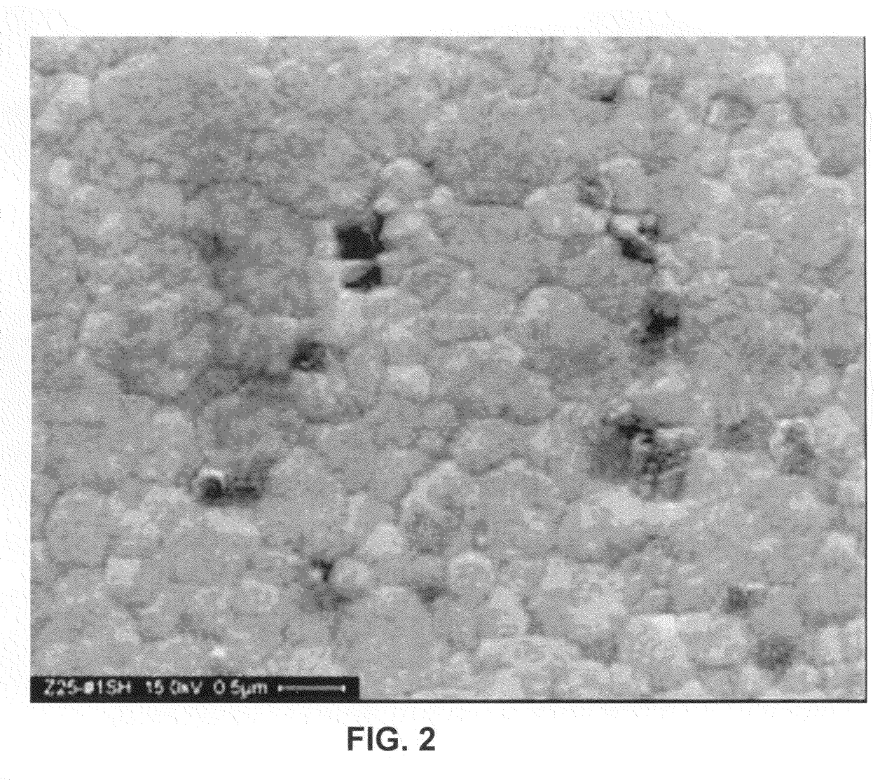

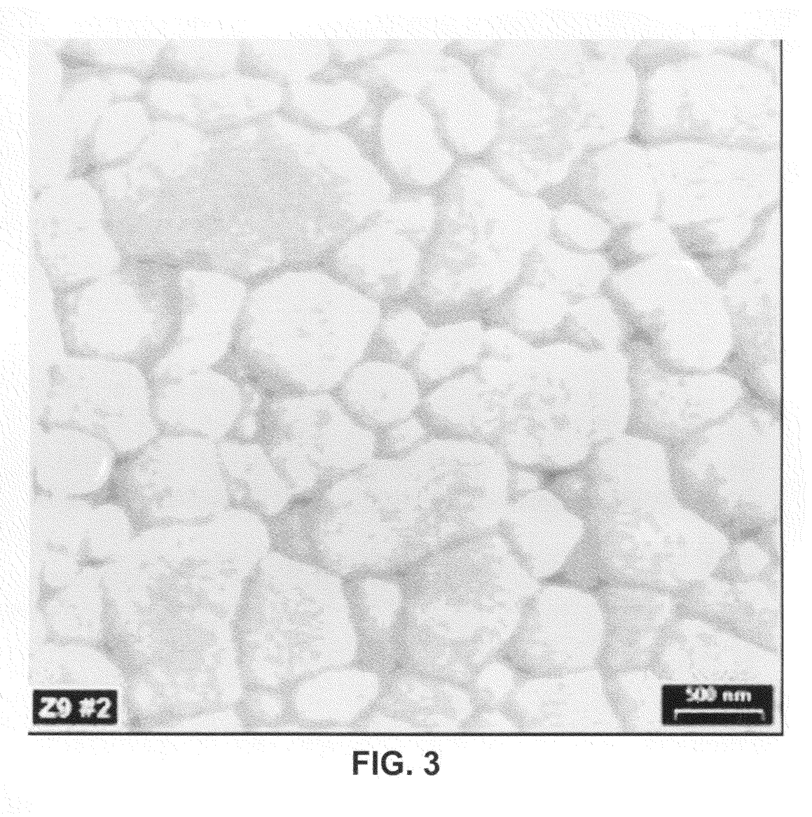

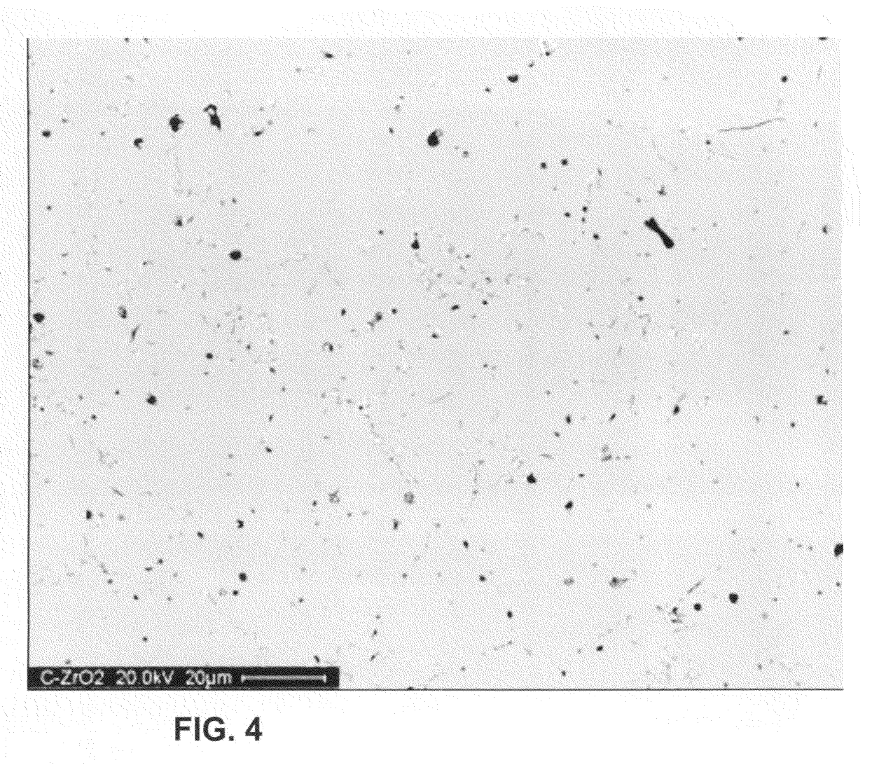

Referring to FIGS. 2 through 4, scanning electron micrograph (SEM) images are provided illustrating portions of stabilized zirconia bodies. In more detail, FIG. 2 includes a SEM picture illustrating the microstructure of a partially stabilized zirconia ceramic body in accordance with embodiments herein. FIG. 3 includes an illustration of a yttria-stabilized zirconia body and FIG. 4 includes an SEM image of a portion of a magnesia-stabilized zirconia body. In a comparison of FIGS. 2-4, differences in the microstructure between the presently disclosed partially stabilized zirconia body and the conventional partially stabilized zirconia bodies are illustrated. Notably, the partially stabilized zirconia body of FIG. 2 has a fine-grained crystalline structure having crystalline grains of an average size of less than about 1 micron as compared to the bodies illustrated in FIGS. 3 and 4. In fact, the zirconia materials of FIGS. 3 and 4 have larger grains, and particularly the magnesia-containing material of FIG. 4 illustrates large grains on the order of about 10 to about 20 microns, the grains being defined by sharp cornered grain boundaries.

In accordance with one embodiment, the partially stabilized zirconia ceramic body has crystalline grains having an average grain size of less than about 2 microns, such as less than 1 micron, or even less than about 0.8 microns. In one particular embodiment, the ceramic body includes crystalline grains having an average grain size within a range between about 0. 1 microns and 2 microns.

In further reference to the characteristics of the ceramic bodies having the PSZ material, as described previously, the ceramic body can include at least two stabilizing species. In accordance with one particular aspect, the PSZ material includes only two stabilizing species, and more particularly, only yttria and magnesia. Notably, the presence of yttria and magnesia are particularly controlled such that the final formed material has a particular mol % fraction of yttria/magnesia having suitable mechanical properties. Herein, mol % fraction refers to the fraction of the yttria content divided by the magnesia content, wherein the contents of the yttria and magnesia are measured in mol percent (mol %). In accordance with one particular embodiment, the mol % fraction of yttria/magnesia is not less than about 0.5. That is, the mol percent of yttria within the final-formed PSZ material is not less than about half of the mol percent of magnesia present within the final-formed PSZ material. In certain other embodiments, the mol % fraction of yttria/magnesia is greater, such as not less than about 0.7, not less than about 0.8, not less than about 0.9, or even not less than about 1.0.

In certain embodiments, it is particularly suitable for the partially stabilized zirconia material to be a yttria-rich material, which contributes to certain mechanical properties. In such instances, the mol % fraction of yttria/magnesia is at least 1. In fact, in certain embodiments, the mol % fraction of yttria/magnesia is within a range between 1 and 10, such as within a range between about 1 to about 5.0, or even within a range between 1 and about 3.0.

In further reference to the chemical composition of the partially stabilized zirconia material, generally the ceramic body contains not less than about 1.5 mol % yttria. In other embodiments, the concentration of yttria may be greater, such as not less than about 1.75 mol %, 2.0 mol %, 2.5 mol %, and more particularly within a range between about 2.0 mol % and about 5.0 mol %, or even between about 2.0 mol % and about 3.5 mol %.

The PSZ material generally contains not greater than about 5.0 mol % magnesia. In fact, certain embodiments have less magnesia, such as not greater than about 4.0 mol %, 3.0 mol %, 2.0 mol %, and more particularly an amount of magnesia within a range between about 0.5 mol % and about 4.0 mol %.

Accordingly, the final-formed partially stabilized zirconia material includes an amount of phase stabilizer of not greater than about 10 mol % of the total mols of phase stabilizing species. Other embodiments may use less total phase stabilizer content, such as on the order of not greater than about 8 mol %, not greater than about 7 mol %, not greater than about 6 mol % and particularly within a range between about 2 mol % and about 10 mol %.

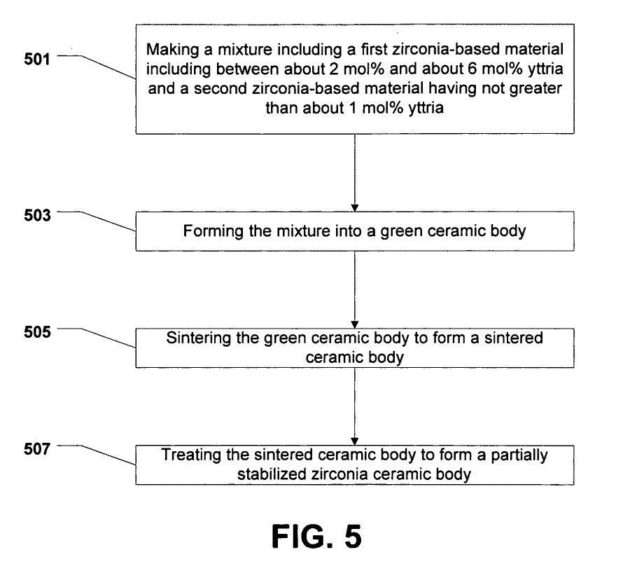

FIG. 5 includes a flow chart illustrating a method of forming a ceramic body in accordance with another embodiment. In particular, the ceramic body can be a partially stabilized zirconia body. While the foregoing has described a method of forming a partially stabilized zirconia material utilizing more than one stabilizing species, according to other embodiments, the ceramic body can be formed from two different zirconia-based materials, wherein one of the zirconia-based materials includes a stabilizing species, and more particularly, the final-formed ceramic body is a zirconia-based material having a single stabilizing species. Notably, such a process is based upon the addition and combination of discrete zirconia-based raw materials.

As illustrated, the process of forming the ceramic body can be initiated at step 501 by making a mixture including a first zirconia-based material having between about 2 mol % and about 6 mol % yttria and a second zirconia-based material having not greater than about 1 mol % yttria. Generally, the formation of the mixture is such that the amount of the first zirconia-based material is equal to or greater than the amount of the second zirconia-based material powder. As will be appreciated, the zirconia-based materials can be powder materials. Moreover, reference herein to a zirconia-based material is reference to a material having a majority amount of zirconia. In certain instances, particularly in reference to the second zirconia-based material, the material can consist essentially of zirconia material minus any stabilizing species.

The mixture can include between about 50 wt % and about 85 wt % of the first zirconia-based material of the total weight of the mixture. In certain instances, the mixture can be formed such that the first zirconia-based material can be present in an amount between about 60 wt % and about 85 wt %, such as between 70 wt % and about 80 wt %, such as between about 75 wt % and about 80 wt %, such as between about 77 wt % and about 79 wt % of the total weight of the mixture.

The amount of yttria within the first zirconia-based material can be a minor amount, generally not exceeding about 6 mol % yttria. In fact, the yttria content of the first zirconia-based material can be within a range between about 2 mol % and about 4 mol %, between about 2 mol % and about 3.5 mol %, between about 2.5 mol % and about 3.2 mol %, or even between about 2.7 mol % and about 3.1 mol %. Particular embodiments can utilize a first zirconia-based material having a yttria content of about 3 mol %.

The mixture can include between about 5 wt % and about 50 wt % of the second zirconia-based material of the total weight of the mixture. In certain instances, the mixture can be formed such that the second zirconia-based material can be present in an amount between about 10 wt % and about 40 wt %, between about 10 wt % and about 30 wt %, between about 10 wt % and about 25 wt %, such as between about 18 wt % and about 23 wt % of the total weight of the mixture.

In particular instances, the amount of yttria within the second zirconia-based material can be a minor amount, generally not exceeding about 1 mol % yttria. In fact, the yttria content of the second zirconia-based material can be not greater than about 0.5 mol %, such not greater than about 0.25 mol %, or even not greater than about 0. 1 mol %. Particular embodiments may use a second zirconia-based material that is yttria-free, that is, a compound being essentially free of yttria.

It will be appreciated, that in some embodiments, the second zirconia-based material can include other stabilizing species, such as magnesia. In such instances, the second zirconia-based material can be a magnesia-containing zirconia powder, and thus the forming process and final composition can be similar to or the same as that described above in accordance with the process of FIG. 1.

Still, certain ceramic based materials can be formed from a second zirconia-based material that can be essentially free of any stabilizing species as described herein. In particular, the second zirconia-based material can be essentially free of magnesia and yttria. Certain embodiments may utilize a second zirconia-based material that consists essentially of zirconia. The second zirconia-based material that consists essentially of zirconia can include some impurity elements and compounds, which in total are present in an amount of less than 2%, such as less than 1%, less than about 0.5% less than 0.25%, or even less than about 0. 1% of the total percentage of the zirconia material.

The first and second zirconia-based materials can have the same surface area of the yttria-containing powder and magnesia-containing powder described herein in other embodiments. That is, the specific surface area of the first and second zirconia-based materials can be at least about 3 m²/g. In fact, in other embodiments, the specific surface area can be greater, such as at least about 5 m²/g, at least about 8 m²/g, 10 m²/g, 12 m²/g, 15 m²/g, 20 m²/g, or even 30 m²/g. According to a particular embodiment, the first and second zirconia-based material can have a specific surface area within a range between about 3 m²/g and about 30 m²/g, between about 5 m²/g and about 25 m²/g, between about 10 m²/g and about 25 m²/g, and even more particularly within a range between about 12 m²/g and about 20 m²/g.

The specific surface area of the first and second zirconia-based materials can be increased by first conducting a milling operation on the powder as described herein.

The average particle size of the first and second zirconia-based materials are such that they facilitate formation of a partially stabilized zirconia material having a fine-grained structure suitable for high strength mechanical applications. As such, in one particular embodiment, the first and second zirconia-based materials can have an average particle size of not greater than about 5 microns. Still, in other embodiments, this average particle size may be less, such as not greater than about 3 microns, not greater than about 2 microns, not greater than about 1 micron, not greater than about 0.5 microns, or even not greater than about 0.3 microns. In accordance with one particular embodiment, the first and second zirconia-based materials has an average particle size within a range between about 0.01 microns and about 2.0 microns, between about 0.05 microns and about 0.5 microns, or even between about 0.09 and about 0.5 microns.

In addition to the first and second zirconia-based materials, the mixture can contain other components, for example other oxides. In one embodiment, the mixture can include a minor amount of an alumina material (e.g. an alumina-containing powder), which can lessen excess grain growth during forming. In certain embodiments, the mixture can include not greater than about 10 wt % of an alumina-containing powder, such as between about 1 wt % and about 10 wt %, between about 1 wt % and about 5 wt %, such as between about 1 wt % and about 3 wt %, or even between about 1 wt % and about 2 wt %. Particular embodiments can use between about 1.2 wt % to about 1.5 wt % alumina.

The alumina material can include at least about 95% alumina. In other embodiments, the alumina material can be purer, such that it includes at least about 98% alumina, 99% alumina, or even 99.5% alumina. The balance of the alumina material may include other elements, compounds or impurities, such as metal oxides, which can be present in minor amounts. Typically, any of the other elements, compounds, or impurities are present in amounts on the order of parts per million or less.

The alumina material can have certain specific surface area and average primary particles sizes tailored to the process to facilitate the formation of the partially stabilized zirconia materials described herein. As such, in certain embodiments, the alumina-containing powder can have a specific surface area that is at least about 3 m²/g, at least about 5 m²/g, 10 m²/g, 12 m²/g, 15 m²/g, 20 m²/g, or even at least about 30 m²/g. According to a particular embodiment, the specific surface area of the alumina-containing powder is within a range between about 3 m²/g and about 30 m²/g, between about 5 m²/g and about 25 m²/g, between about 10 m²/g and about 25 m²/g, or even between about 12 m²/g and about 20 m²/g

The average particle size of the alumina material can be generally micron size, such that in certain embodiments, it is not greater than about 5 microns. In certain other instances, the aluminum-containing powder can be sub-micron size such that the average particle size is within a range between about 0.01 microns and about 1 micron.

As provided above with regard to alumina, formation of the mixture of the first and second zirconia-based materials can include the addition of other components, for example other oxides. Such oxides, including for example alumina, can be added to the mixture separately, such as a separate powder material. In still other instances, other oxides, such as alumina, can be integrated within the zirconia-based materials, such that the oxide materials may not necessarily be added separately from the zirconia powders. For example, the alumina can be integrated with the first zirconia-based material, such as in a raw material, or by pre-mixing the two components together. Alternatively, the alumina material can be integrated with the second zirconia-based material, such that it can be combined with the material as a raw material or by premixing the alumina and second zirconia-based material prior to addition of the first zirconia-based material.

After combining the proper amounts of the powder components, such materials may be mixed, such as by a dry mixing process or a wet mixing process. It will be appreciated that the final mixture can include particular contents of the first and second zirconia-based materials and the alumina containing material such that the total weight percent does not exceed 100%. In accordance with one particular embodiment, mixing includes a wet mixing process, for example a ball milling process. That is, in certain instances the mixing procedure can include combining the mixture of raw materials with an aqueous vehicle and a dispersant and milled.

According to a particular embodiment, the mixing process is a wet mixing process including forming a slurry using the dry powder mixture containing the first and second zirconia-based materials and the alumina material. The slurry can include at least about 50 wt % water, and more particularly at least about 50 wt % to about 65 wt % water. The slurry may further contain a dispersant, such as ammonium-containing material, for example, ammonium citrate.

Generally the mixing duration is at least 4 hours. In other embodiments, the mixing duration is longer, such as at least about 10 hours, at least about 12 hours, or even at least about 15 hours. According to a particular embodiment, the milling duration is within a range between about 10 hours and about 25 hours.

In such embodiments utilizing a wet mixing process, the slurry can be dried, which may depend in part upon the forming method. In certain instances, the drying process can be a spray drying process, wherein the slurry is extracted from the mixer or mill and additional materials can be added to facilitate the spray drying process. For example, in one embodiment, a binder material is added in a minor amount, such as on the order of less than about 5 wt % of the total slurry weight, to facilitate the formation of a spray dried binderized powder.

After suitably mixing the raw materials, the process continues at step 503 by forming the mixture into a green ceramic body. The forming process can be used to form a “green ceramic body”, otherwise an unsintered body, which can be the same processes as described herein in other embodiments.

After forming the green ceramic body, the process continues at step 505 by sintering the green ceramic body to form a sintered ceramic body. The sintering process can be the same as described herein in accordance with other embodiments.

After sintering at step 505, the process can continue at step 507 by treating the sintered ceramic body to form a partially stabilized zirconia ceramic body. The treating operation facilitates full densification of the final formed zirconia body and improved properties of the final-formed body. Treating can include additional heat treatment of the sintered ceramic body to effect full densification, including those processes described herein in other embodiments (e.g., HIPing).

After conducting the process illustrated in FIG. 5, the final-formed ceramic body can be a PSZ material having superior density, such that it is at least about 95% dense, more particularly at least about 98% dense, and in some embodiments, at least about 99% dense based upon theoretical density calculations.

As such, in particular instances, the final-formed yttria stabilized zirconia body can have a certain composition, such that it includes between about 2.5 mol % to about 3.0 mol %, and more particularly between about 2.5 mol % and about 2.9 mol % yttria. The final-formed yttria-stabilized zirconia body can contain between about 85 mol % and about 98 mol % zirconia, such as between about 90 mol % and about 98 mol % zirconia. The remainder of the body can include alumina, in contents of approximately 0.5 mol % to about 3 mol %. Notably, in particular embodiments, the ceramic body can be essentially free of magnesia.

The partially stabilized zirconia materials of embodiments herein have been formed to have exceptional mechanical properties. For example, the PSZ material can have a Vicker's hardness (Hv), as measured by the indentation test under a 10 Kg load according to ASTM C 1327, of not less than about 10 GPa. In accordance with other embodiments, the hardness can be greater, such as not less than about 11 GPa, or not less than about 12 GPa, within a range between about 10 GPa and about 15 GPa, or more particularly between about 12 GPa and about 15 GPa.

Additionally, the partially stabilized zirconia material of the embodiments herein can be quite strong, having a flexure strength measured by the 4-point bending method according to ASTM C 161, of at least about 800 MPa. In accordance with other certain embodiments, the flexure strength of the PSZ material is greater, such as at least about 900 MPa, at least 1000 MPa, or even at least 1100 MPa. In accordance with a particular embodiment, the flexure strength of the PSZ material is within a range between about 1000 MPa and 1500 MPa.

Additionally, the partially stabilized zirconia material of the embodiments herein also possesses superior toughness. As such, in accordance with embodiments herein, the ceramic body has a fracture toughness (K1c), as measured by the indentation fracture technique under a 10 Kg load, of not less than about 5.5 MPam^{(1/2)}. In accordance with more particular embodiments, the toughness may be greater, such as on the order of not less than about 6 MPam^{(1/2)}, not less than about 7.0 MPam^{1/2)}, not less than about 7.5 MPam^{(1/2)}, not less than about 7.75 MPam^{(1/2)}, not less than about 8.0 MPam^{(1/2)}, or even not less than about 10 MPam^{(1/2)}. In one particular embodiment, the toughness is within a range between about 5.5 MPam^{(1/2)} and about 12 MPam^{(1/2)}, between about 7.75 MPam^{(1/2)} and about 12 MPam^{(1/2)}, between 7.75 MPam^{(1/2)} and about 11 MPam^{(1/2)}, between 7.75 MPam^{(1/2)} and about 10 MPam^{(1/2)}.

Certain of the ceramic bodies herein demonstrate a particular resistance to degradation in environments containing water and elevated temperatures. For example, the ceramic bodies of embodiments herein can have a hydrothermal degradation factor of not greater than about 1% linear expansion after exposure to 69 psi of water at a temperature of 150° C. for 120 hours. In other instances, the hydrothermal degradation factor can be less, such as not greater than about 0.9%, not greater than about 0.8%, not greater than about 0.75%, or even not greater than about 0.7% linear expansion after exposure to 69 psi of water at a temperature of 150° C. for 120 hours.

Additionally, in more rigorous testing, certain of the ceramic bodies of embodiments herein demonstrated a hydrothermal degradation factor of not greater than about 2% linear expansion after exposure to 225 psi of water at a temperature of 200° C. for 48 hours. In fact, certain ceramic materials of the embodiments herein demonstrate a hydrothermal degradation factor of not greater than about 1.9%, not greater than about 1.8%, not greater than about 1.75%, not greater than about 1.6%, or even not greater than about 1.5% linear expansion after exposure to 225 psi of water at a temperature of 200° C. for 48 hours.

It will be appreciated that a standard test (i.e., ASTM) for measuring toughness is not subscribed to however, toughness (indentation strength or indentation fracture) was measured according to published guidelines that are widely accepted within the ceramics industry. Data disclosed herein derived from an indentation strength test followed the procedures disclosed in the following reference: P. Chantikul, G. R. Anstis, B. R. Lawn, and D. B. Marshall, A Critical Evaluation of Indentation Techniques for Measuring Fracture Toughness: II, Strength Method, J. Am. Ceram. Soc., Vol. 64 (1981), No. 9, pp. 539-543. Data disclosed herein derived from an indentation fracture test followed the procedures disclosed in the following reference: G. R. Anstis, P. Chantikul, B. R. Lawn, and D. B. Marshall, A Critical Evaluation of Indentation Techniques for Measuring Fracture Toughness: I, Direct Crack Measurements, J. Am. Ceram. Soc., Vol. 64 (1981), No. 9, pp. 533-538.]

As will be appreciated, the final formed partially stabilized zirconia material can include minor amounts of other oxide components originally contained within the dry powder mixture. For example, an alumina-containing species, which can be present in the final-formed partially stabilized zirconia body in an amount within a range between about 0.5 mol % and about 10 mol %.

### EXAMPLES

The following examples detail processes for forming ceramic bodies containing a partially stabilized zirconia material, certain mechanical properties of such bodies, and comparisons of such materials against conventional materials.

### Example 1 (E1)

Samples were formed according to the following process to make a partially stabilized zirconia ceramic material. A mixture of powder was made using 78.94 wt % of a yttria-containing zirconia powder (approximately 3 mol % yttria) commercially available as YZ-1 10 from Saint-Gobain, having a particle size of 0.7 microns, and a specific surface area of 9.5 m²/g. The mixture also contained 19.73 wt % of a magnesia-containing zirconia powder (9 mol % magnesia) commercially available as TZ-9Mg from Tosoh, having a measured particle size of about 0.48 micron and a specific surface area of 7.7 m²/g. An alumina containing-powder was added in an amount of 1.33 wt %, commercially available as Ceralox APA 0.5, having a particle size of 0.3 microns, a specific surface area of 8.0 m²/g, and having an alumina content of 99.96%. The impurity levels for certain oxides within the yttria-containing zirconia powder and magnesia-containing zirconia powder are provided below in Table 1.

TABLE 1

| | TZ-9MG | YZ-110 batch |
|---|---|---|
| | Lot#SO9M664P | YN-04-38 |
| Oxide | (ppm) | (% or ppm) |
| Al₂O₃ | 160 | 0.25% |
| CaO | 300 | 664 ppm |
| CeO2 | <10 | <10 ppm |
| CoO | <10 | |
| Cr2O3 | <10 | |
| CuO | <10 | |
| Fe₂O₃ | 50 | 174 ppm |
| HfO2 | 19000 | 1.81% |
| K2O | 10 | |
| MgO | 31000 | <10 ppm |
| MnO | <10 | |
| Na₂O | 20 | <10 ppm |
| Nb2O5 | <10 | |
| SiO₂ | 310 | <10 ppm |
| TiO₂ | 180 | 1392 ppm |
| V2O5 | <10 | |
| Y2O3 | 80 | 5.05% |
| ZnO | <10 | |
| % ZrO2 | 94.89 | 92.67 |
| (by difference) | | |

After forming the dry powder mixture, a slurry was formed by adding 58.0 wt % water and 0.5 wt % of solids ammonium citrate for use as a dispersant. The slurry was then ball-milled for a duration 19.5 hours. After milling, the slurry was extracted from the mill and a binder (NALCO 94QC23 1) was added in preparation for spray drying. Spray drying of the slurry was completed using a Buchi Mini Spray Dryer Model B-191, using an inlet temperature of 180° C. to form a dried agglomerated powder having an average secondary particle size within a range of between approximately 25 μm to about 50 μm. The powder was sieved through a 125 micron mesh after spray drying.

The dried powder was formed into samples using a combination of pressing techniques that included an initial uni-axial pressing operation using a Carver Laboratory Press Model C and conducted at a pressure of 3,000 lbs. of force to sufficiently shape the samples. The uni-axially pressed samples were then cold-isostatically pressed using an EPS Inc. Isomax 30 Model Automatic Isostatic System at a pressure of 207 MPa (30 ksi) at room temperature to form green ceramic samples.

The green ceramic samples were then sintered. Sintering was conducted over a range of temperatures such that different samples were sintered at different temperatures over a range from 1400° C. to 1550° C. to study the effects of the sintering temperature on the mechanical properties (see Tables 2 and 3 below). Additionally, the sintering times were varied for different samples, either 45 minutes or 75 minutes, to test the effects of the sintering duration on certain mechanical properties. After sintering, the samples were cooled to room temperature at rates that differed depending upon the range of temperatures, and notably a decreasing rate with decreasing temperature. That is, from the sintering temperature to approximately 1200° C. the cooling rate was approximately 18° C./min, and within the temperature range between 1200° C. to 1000° C. the cooling rate was approximately 10° C./min. Within the temperature range between 1000° C. to 600° C. the cooling rate was approximately 6° C./min.

The samples were then subject to a hot-isostatic-pressing (HIPing) operation to aid post-sintering densification and potentially modify certain mechanical properties. Each sample was loaded into a HIPing chamber containing a powder bed of 3 wt % magnesia-containing zirconia powder. HIPing was completed at a maximum HIPing temperature of 1400° C., a maximum HIPing pressure of 206 MPa (30 ksi), and held at this temperature and pressure for a duration of 45 minutes in an atmosphere of argon.

Mechanical tests were performed on each of the samples including hardness, toughness, and density. For each of the samples, hardness was measured using the Vickers indentation under a 10 Kg load in accordance with ASTM C1327. Toughness was measured according to the indentation fracture method under a 10 Kg load according to widely accepted testing guidelines as described herein. Density for each of the samples was measured according to ASTM C20.

Table 2 illustrates the mechanical properties (Hardness, Toughness, and Density) of eight samples (A-H), fired at different sintering temperatures between 1400° C. and 1550° C., for a duration of 45 minutes or 75 minutes. A portion of Table 2 provides the mechanical properties of the samples after sintering, prior to the HIPing operation, while another portion of Table 2 provides data comparing the mechanical properties of the samples after a final HIPing operation.

TABLE 2

| | Sintering | | | | | | | |
|---|---|---|---|---|---|---|---|---|
| | Temperature (° C.) | | | | | | | |
| | 1400 | | 1450 | | 1500 | | 1550 | |
| | Sample | | | | | | | |
| | A | B | C | D | E | F | G | H |
| Sintering Time | 45 | 75 | 45 | 75 | 45 | 75 | 45 | 75 |
| (min.) | | | | | | | | |
| Hardness (Gpa) | NA | NA | 11.02 | 11.40 | 11.7 | 11.71 | 11.61 | 11.72 |
| Toughness | NA | NA | 7.41 | 7.79 | 7.58 | 7.91 | 8.01 | 8.16 |
| (MPam^{(1/2)}) | | | | | | | | |
| Density (% | 94.3 | 96.3 | 98 | 97.5 | 99.6 | 99.2 | 99.8 | 99.9 |
| Theoretical) | | | | | | | | |

After HIPing

| | | | | | | | | |
|---|---|---|---|---|---|---|---|---|
| Hardness (GPa) | 12.20 | 12.09 | 12.15 | 12.13 | 11.70 | 11.71 | 11.61 | 11.72 |
| Toughness | 8.08 | 7.85 | 8.42 | 8.38 | 8.40 | 8.50 | 8.18 | 8.58 |
| (MPam^{(1/2)}) | | | | | | | | |
| Density (% | 100.3 | 100.3 | 100.2 | 99.7 | 100.3 | 100.0 | 100.3 | 100.4 |
| Theoretical) | | | | | | | | |

Table 2 illustrates the effect of the HIPing operation on the mechanical properties. Generally, the samples subject to the HIPing operation had improved mechanical properties in all aspects, particularly with respect to the hardness and toughness. Interestingly, it appears that the samples demonstrated a trend of decreasing hardness with increasing sintering temperatures, while the toughness tended to increase with increasing sintering temperature. It will be noted that the density for the samples tested after the HIPing procedure have densities in excess of 100%, since the density is compared to a theoretical density value derived mathematically based upon the expected composition of the final formed part, which does not account for the presence of minor amounts of other materials within the final formed article.

### Example 2 (E2)

Additional samples were prepared using the same procedures as described in Example 1, however the components of the original dry powder mixture were changed. The original dry powder mixture contained 78.77 wt % of approximately 3 mol % yttria-containing zirconia powder commercially available as YZ-1 10 from Saint-Gobain, 19.92 wt % of 8 mol % magnesia-containing zirconia powder commercially available as MSZ-8.0 from Daiichi, having a particle size of 0.3 microns, and a specific surface area of 3.6 m²/g. The mixture further contained 1.31 wt % alumina-containing powder commercially available as Ceralox APA 0.5 (a particle size of 0.3 microns, a specific surface area of 8.0 m²/g, and having an alumina content of 99.96%).

Table 3 below provides comparison of the mechanical properties of eight samples (I-P) fired at sintering temperatures between 1400° C. and 1550° C., for a duration of 45 minutes or 75 minutes. A portion of Table 3 provides the mechanical properties of the samples after sintering, prior to the HIPing operation, while another portion of Table 3 provides data comparing the mechanical properties of the samples after a final HIPing operation.

TABLE 3

| | Sintering | | | | | | | |
|---|---|---|---|---|---|---|---|---|
| | Temperature (° C.) | | | | | | | |
| | 1450 | | 1500 | | 1550 | | 1600 | |
| | Sample | | | | | | | |
| | I | J | K | L | M | N | O | P |
| Sintering Time | 45 | 75 | 45 | 75 | 45 | 75 | 45 | 75 |
| (min.) | | | | | | | | |
| Hardness (GPa) | NA | 9.89 | 11.35 | NA | 10.32 | 10.34 | 10.25 | NA |
| Toughness | NA | 4.64 | 4.55 | NA | 4.12 | 3.98 | 3.76 | NA |
| (MPam^{(1/2)}) | | | | | | | | |
| Density (% | 94.3 | 96.6 | 96.6 | 96.5 | 97.2 | NA | 96.8 | NA |
| Theoretical) | | | | | | | | |

After HIPing

| | | | | | | | | |
|---|---|---|---|---|---|---|---|---|
| Hardness (GPa) | NA | 10.94 | 10.93 | NA | 10.70 | NA | 10.55 | NA |
| Toughness | NA | 4.25 | 4.17 | NA | 3.95 | NA | 3.79 | NA |
| (MPam^{(1/2)}) | | | | | | | | |
| Density (% | NA | 98.7 | 98.4 | 98.0 | 98.3 | 97.7 | 97.2 | NA |
| Theoretical) | | | | | | | | |

As illustrated in Table 3, generally the HIPing process increased the mechanical properties, particularly the hardness and density, however the toughness of the samples appear to be less effected by the HIPing process. In a comparison of Tables 2 and 3, samples A-H generally had superior mechanical properties over the samples I-P in Table 3. Without wishing to be tied to a particular theory, the Inventors suggest that characteristics of the raw materials used and the ratio of the materials in the original mixture may have effected the change in mechanical properties. For example, the particle size and specific surface area of certain materials, such as the magnesia-containing zirconia powder affect the mechanical properties.

### Example 3 (E3)

Additional samples were prepared using the same procedures as described in Example 1, however the components of the original dry powder mixture were changed to contain: 69.06 wt % of approximately3 mol % yttria-containing zirconia powder commercially available as YZ-1 10 from Saint-Gobain, 29.6 wt % of 9 mol % magnesia-containing zirconia powder commercially available as TZ-9Mg from Tosoh, and 1.34 wt % alumina-containing powder commercially available as Ceralox APA 0.5 (a particle size of 0.3 microns, a specific surface area of 8.0 m²/g, and having an alumina content of 99.96%). Table 4 below provides comparison of the mechanical properties of one of the samples formed from the dry powder mixture noted above, after a HIPing operation.

TABLE 4

| | |
|---|---|
| Sintering Temperature (° C.) | 1500 |
| Sample | Q |
| Sintering Time (min.) | 45 |
| Hardness (GPa) | 12.17 |
| Toughness (MPam^{(1/2)}) | 8.91 |
| Density (% Theoretical) | 100.6 |

Notably, the sample illustrates superior density, hardness, and toughness, particularly in comparison to samples I-P of Table 3. Again, without wishing to be tied to a particular theory, differences in the mechanical properties may be attributed to the different raw materials, the differences in the ratio between the materials or both.

### Comparative Example 1

Before detailing the differences of the present partially stabilized zirconia material to state of the art stabilized zirconia materials, it should be noted that mechanical properties of materials can be measured using various techniques, and published mechanical properties can oftentimes be misleading. As such, certain values are not directly comparable unless they are conducted using the same testing techniques. Moreover, it is further understood that pressures from the industry to provide customers with improved materials may lead manufacture's to use the most advantageous data for marketing purposes. With this understanding, the following comparative examples were conducted with precision according to strict testing guidelines to accurately establish the performance characteristics of examples herein and conventional materials.

The following data provided in Table 5 set forth comparative data for the samples made according to the procedures described in Example 1 (A) as compared to conventional samples, CE1 and CE2. CE1 corresponds to a conventional TZP material using only yttria as the stabilizing species and having the composition of approximately 3 mol % yttria-containing zirconia, commercially available from Saint-Gobain Advanced Ceramics as YZ-110. Conventional sample CE2 corresponds to a PSZ material incorporating only magnesia as the stabilizing species having the composition of and commercially available from Carpenter Advanced Ceramics as MS grade Zirconia.

TABLE 5

| | Hardness | Toughness |
|---|---|---|
| Sample | (GPa) | (MPam^{(1/2)}) |
| A (2.3 mol % Y₂O₃/1.9 mol % MgO) | 12.23 | 7.99 |
| CE1 (3 mol % Y₂O₃) | 12.72 | 4.57 |
| CE2 (8 mol % MgO) | 9.70 | 5.88 |

The hardness and toughness values presented in Table 5 were generated using the Vickers indentation test under a 10 Kg load in accordance with ASTM standard C1327 and the indentation fracture method using a 10 Kg load and testing procedures referenced herein.

Generally, yttria-stabilized zirconia bodies are known for their high strength and hardness but sacrifice this property for toughness, as illustrated by the data in Table 5. Conventional magnesia-stabilized zirconia materials are known for toughness in excess of yttria-stabilized zirconia materials, while having less hardness (and expected strength) than the yttria-containing counterparts, results also illustrated in Table 5. Accordingly, a zirconia body having a combination of yttria and magnesia as stabilizing species would be expected to have mechanical properties between the values of the conventional samples, that is, a hardness between 9.70 MPa and 12.72 MPa and a toughness between 4.57 MPam^{(1/2)} and 5.88 MPam^{(1/2)}. However, as illustrated in Table 5, the hardness of sample A is comparable to that of CE1, and more unexpectedly, the toughness of sample A exceeds the toughness of both conventional samples, most surprisingly exceeding the magnesia-containing zirconia sample CE2. While the mechanisms resulting in such unexpected properties is not completely understood, it is believed that such properties are due to one or a combination of the following: the particular raw materials, characteristics of the raw materials, the particular ratio of yttria and magnesia, the microstructure of the as-formed material, and/or particulars of the forming process.

### Example 4 (E4)

Additional samples were prepared using the same procedures as described in Example 1, however, the components of the original dry powder mixture were changed. The original dry powder mixture contained 77.88 wt % of approximately 3 mol % yttria-containing zirconia powder commercially available as YZ-110 from Saint-Gobain, 20.83 wt % of pure zirconia powder commercially available as TZ-0 from Tosoh, having a particle size of 0.23 microns, and a specific surface area of 15.9 m²/g. The mixture further contained 1.30 wt % alumina-containing powder commercially available as Ceralox APA 0.5. The impurity levels for certain oxides within the pure zirconia powder are provided in Table below.

TABLE 6
Impurities in TZ-0 powder

| | TZ-0 |
|---|---|
| | Lot#Z005551P |
| Oxide | % |
| Al₂O₃ | <0.005 |
| Fe₂O₃ | <0.002 |
| Na₂O | 0.017 |
| SiO₂ | 0.005 |

Sintering was carried out at 1450° C. for 1.3 hrs, which was followed by HIPing carried out at 1400° C. for 45 min under 30 ksi Ar as in Example 1.

FIG. 7 includes a magnified image of a thermally etched polished surface of the E4 sample.

### Comparative Example 2 (2Y-TZP)

A 2Y-TZP sample was obtained, representative of a conventional TZP material using only yttria as the stabilizing species and having the composition of approximately 2 mol % yttria-containing zirconia, commercially available from Tosoh as TZ-2Y.

TABLE 7
Impurities in TZ-2Y powder

| | TZ-2Y |
|---|---|
| | Lot#Z207433P |
| Oxide | % |
| Al₂O₃ | <0.005 |
| Fe₂O₃ | <0.002 |
| Na₂O | 0.018 |
| SiO₂ | 0.007 |

### Comparative Example 3 (2.5Y-TZP)

A sample 2.5Y-TZP was obtained, representative of a conventional TZP material using only yttria as the stabilizing species and having the composition of approximately 2.5 mol % yttria-containing zirconia, commercially available from Tosoh as TZ-2.5Y.

### Comparative Example 4 (YZ-110)

This sample is a conventional TZP material using only yttria as the stabilizing species and having the composition of approximately 3 mol % yttria-containing zirconia, commercially available from Saint-Gobain Advanced Ceramics as YZ-110.

Table 8 below sets forth performance data for Samples E1 and E4 formed according to embodiments herein as compared to the comparative examples 2Y-TZP, 2.5Y-TZP, and YZ-110 representing conventional yttria-stabilized zirconia ceramic materials.

TABLE 8
Comparative Data

| | | | | K1c (MPam^{1/2}) |
|---|---|---|---|---|
| | | | Hv (GPa) | from indentation |
| Material | Firing | Density | under 10 kg | fracture method |
| system | history | (g/cc) | load | with 10 kg load |
| 2Y-TZP | Sinter: 1400 C. | 6.11 | 12.18 ± 0.05 | 5.89 ± 0.29 |
| | HIP: 1400 C. | | | |
| 2Y-TZP | Sinter: 1450 C. | 6.10 | 12.20 ± 0.03 | 6.43 ± 0.20 |
| | HIP: 1400 C. | | | |
| 2Y-TZP | Sinter: 1500 C. | 6.08 | 12.07 ± 0.02 | 7.05 ± 0.52 |
| | HIP: 1400 C. | | | |
| E1 | Sinter: 1450 C. | 6.01 | 12.17 ± 0.02 | 8.21 ± 0.38 |
| | HIP: 1400 C. | | | |
| E4 | Sinter: 1450 C. | 6.01 | 12.37 ± 0.12 | 8.15 ± 0.37 |
| | HIP: 1400 C. | | | |
| 2.5Y-TZP | Sinter: 1350 C. | 6.07 | 12.59 ± 0.08 | 4.07 ± 0.05 |
| | HIP: 1400 C. | | | |
| 2.5Y-TZP | Sinter: 1400 C. | 6.11 | 12.59 ± 0.07 | 4.11 ± 0.07 |
| | HIP: 1400 C. | | | |
| 2.5Y-TZP | Sinter: 1450 C. | 6.10 | 12.56 ± 0.05 | 4.14 ± 0.04 |
| | HIP: 1400 C. | | | |
| 2.5Y-TZP | Sinter: 1500 C. | 6.09 | 12.46 ± 0.04 | 4.18 ± 0.11 |
| | HIP: 1400 C. | | | |
| 2.5Y-TZP | Sinter: 1550 C. | 6.07 | 12.18 ± 0.08 | 4.45 ± 0.10 |
| | HIP: 1400 C. | | | |
| YZ-110 | Sinter: 1500 C. | 6.07 | 12.42 ± 0.08 | 4.30 ± 0.20 |
| | HIP: 1450- | | | |
| | 1500 C. | | | |

As illustrated in Table 8, the samples E1 and E4, representing the ceramic bodies of the embodiments herein, demonstrate superior toughness over all of the conventional, comparative samples. Moreover, the samples E1 and E4 demonstrate equivalent or greater hardness, and as such demonstrate that the improved toughness is not sacrificed for a decrease in the hardness.

Additionally, certain of the E1 and E4 samples and the comparative examples were tested for hydrothermal degradation in an environment of water and elevated temperatures. Such a test was completed to compare the degradation of the materials as compared to conventional materials. The results of the testing are provided in Table 9 below.

TABLE 9

| Testing | | | | | |
|---|---|---|---|---|---|
| conditions | 2Y-TZP | E1 | E4 | 2.5Y-TZP | YZ-110 |
| 150° C./ | ~0.21 mm | Not tested. | Surface | Surface | Surface |
| 120 hrs | surface | | intact, | intact, | intact, |
| with 69 | layer | | 0~0.67% | 0~0.67% | 0~0.34% |
| psi water | completely | | expansion | expansion | expansion |
| pressure | delaminated | | | | |
| 200° C./ | ~0.74 mm | Surface | Surface | Surface | Surface |
| 48 hrs | surface | intact, | intact, | intact, | intact, |
| with 225 | layer | 0~1.0% | 0~1.33% | 0~1.0% | 0~0.75% |
| psi water | completely | expansion | expansion | expansion | expansion |
| pressure | delaminated | | | | |

One of the hydrothermal degradation tests included exposing each of the samples to an environment held at 150° C. for 120 hours and under a constant water pressure of 69 psi. The degradation of the samples was measured by visual observance, which may have revealed any delamination of the material. Additionally, the linear expansion of the samples was measured before the sample was exposed to the environment and after the sample was exposed to the environment to determine the effects of the hydrothermal conditions on the ceramic body. The linear expansion of the samples is an indicator of the tetragonal to monoclinic phase transformation of the ceramic material and the ability to withstand such an environment before mechanical failure. As provided by the data, the 2Y-TZP material was completely delaminated. By contrast the E4 sample was essentially intact, that is, the sample showed no delamination. Also, the E4 sample had minimal linear expansion, comparable to the samples 2.5Y-TZP and YZ-110.

As further provided in Table 9, a second hydrothermal degradation test was conducted at a higher temperature (200° C.) to evaluate the degradation and likelihood of mechanical failure of the ceramic materials in such environments. As clearly demonstrated, the E1 and E4 samples were essentially intact showing no delamination. Additionally, the E1 and E4 samples exhibited very little linear expansion, comparable to that of the 2.5Y-TZP and YZ-110 samples. By contrast, the 2Y-TZP sample demonstrated linear expansion coupled with complete delamination of the outer layers.

While the mechanisms resulting in such unexpected properties provided in Tables 8 and 9 are not completely understood, it is believed that such properties are due to one or a combination of the following: the particular raw materials, characteristics of the raw materials, the microstructure of the as-formed material, and/or particulars of the forming process.

### Comparative Example 5 (Z47)

Another comparative sample was prepared by using the same materials and procedures provided in Example 1, with the exception that the alumina content was increased proportionally. The composition of the Z47 comparative sample was formed from 65.52 wt % of YZ-110, 16.36 wt % of TZ-9Mg, and 18.11 wt % of Ceralox Alumina. The Z47 sample was sintered at 1450° C. and HIPing was carried out at 1400° C. as described in Example 1. Table 10 includes comparative data illustrating certain mechanical properties of the Z47 sample as compared to a stabilized zirconia body according to embodiments herein (Example 1).

TABLE 10

| | MOR strength | K1c (MPam^{1/2}) by | Hv |
|---|---|---|---|
| | (MPa) | indention strength | (GPa) |
| Example 1 | 1334.3 ± 144.8 | 13.0 ± 5.5 | 12.23 |
| Z47 | 1191.9 ± 128.5 | 6.7 ± 0.04 | 14.03 |

As provided in Table 10, the Z47 sample demonstrated a comparable, and in fact, slightly greater hardness (Hv) value as compared to the Example 1 sample. However, as further provided by the data, the Example 1 composition demonstrated significantly greater strength (MOR) and toughness (K1c) than the Z47 sample having a significantly greater alumina content.

The following disclosure has described embodiments of partially stabilized zirconia ceramic bodies. While it has been suggested in certain literature that one or more stabilizing species may be used, and that a combination of stabilizing species may yield a zirconia material having different properties, such literature is concerned with different compositions. In fact, the literature appears focused on the reduction of yttria content by substitution of magnesia for yttria, and more particularly magnesia-rich compositions incorporating greater amounts of magnesia and using yttria in minor amounts as a co-stabilizer. The conventional approach is understandable, as it was expected that yttria-rich zirconia materials would have undesirable low-temperature degradation, especially in conditions where the material is exposed to water. Stated another way, certain state-of-the-art references teach co-stabilizing with slight amounts of yttria to raise the strength without sacrificing the toughness afforded by the magnesia stabilizing species. See, for example, U.S. Pat. No. 6,723,672; H. Olapinski et al., “High Temperature Durability of Zirconia”, Feldmuhle Aktiengesellshaft, Werk Sudplastick und Keramik Fabrikstrasse 23-29, D73 10 Plochingen; Meschke et al., “Microstructure and thermal Stability of Fine-Grained (Y, Mg)-PSZ Ceramics with Alumina Additions”, Journal of the European Ceramic Society, 11 (1993), 481-486; Meschke et al., “Preparation of High-Strength (Mg, Y)-Partially Stabilised Zirconia by Hot Isostatic Pressing”, Journal of European Ceramic Society, 17 (1997), 843-85 land Wang et al., “The Preparation and Microstructures of Micro-Grained PSZ (MGPSZ) Ceramics”, Ceram. Int. Symp. Ceram. Mater. Compon. Engines, 5^{th} (1995).

Embodiments herein are directed to partially stabilized zirconia bodies that have demonstrated a combination of improved mechanical characteristics and hydrothermal degradation characteristics. While not fully understood, it is theorized that in either case of compositions using multiple stabilizing species or compositions formed from distinct raw materials according to embodiments herein, there may be certain differences in microstructure from known ceramic bodies. It is theorized that there may be a non-homogenous dispersion of certain compounds, such that islands of a composition or distinct phase exist within a matrix of the zirconia material. Additionally, other factors such as the characteristics of the raw materials, ratio of compounds used, processing methods and other features described herein may facilitate the formation of the partially stabilized zirconia bodies having the improved mechanical characteristics.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description, with each claim standing on its own as defining separately claimed subject matter.

1. A ceramic material formed from:
a mixture comprising:
between about 50 wt % and about 85 wt % of a first zirconia-based material comprising between about 2 mol % and about 6 mol % yttria;
between about 5 wt % and about 49 wt % of a second zirconia-based material comprising not greater than about 1 mol % yttria; and
between about 1 wt % and about 10 wt % of an alumina material.

2. The ceramic material of claim 1, wherein the mixture comprises between about 70 wt % and about 80 wt % of the first zirconia-based material.

3. (canceled)

4. The ceramic material of claim 1, wherein the mixture comprises between about 10 wt % and about 25 wt % of the second zirconia-based material.

5. (canceled)

6. The ceramic material of claim 1, wherein the mixture comprises between about 1 wt % and about 5 wt % of the alumina material.

7. (canceled)

8. The ceramic material of claim 1, wherein the first zirconia-based material comprises between about 2 mol % and about 4 mol % yttria.

9. (canceled)

10. The ceramic material of claim 1, wherein the second zirconia-based material comprises not greater than about 0.5 mol % yttria.

11. The ceramic material of claim 10, wherein the second zirconia-based material is essentially free of yttria.

12. (canceled)

13. The ceramic material of claim 1, wherein the second zirconia-based material comprises an average particle size of less than about 1 micron.

14-21. (canceled)

22. A ceramic material comprising:
a partially stabilized zirconia ceramic body comprising:
a toughness (K1c) of not less than about 5.5 MPam^{1/2} as measured according to an indentation fracture method using a 10 Kg load; and
a hydrothermal degradation factor of not greater than about 1% linear expansion after exposure to 69 psi of water at a temperature of 150° C. for 120 hours.

23. The ceramic material of claim 22, wherein the partially stabilized zirconia body is essentially intact after exposure to 69 psi of water at a temperature of 150° C. for 120 hours.

24. (canceled)

25. The ceramic material of claim 22, wherein the partially stabilized zirconia body comprises a hydrothermal degradation factor of not greater than about 2% linear expansion after exposure to 225 psi of water at a temperature of 200° C. for 48 hours.

26-27. (canceled)

28. The ceramic material of claim 22, wherein the toughness (K1c) is not less than about 6 MPam^{1/2} as measured according to an indentation fracture method using a 10 Kg load.

29. The ceramic material of claim 28, wherein the toughness (K1c) is not less than about 7 MPam^{1/2} as measured according to an indentation fracture method using a 10 Kg load.

30. The ceramic material of claim 29, wherein the toughness (K1c) is not less than about 7.5 MPam^{1/2} as measured according to an indentation fracture method using a 10 Kg load.

31. The ceramic material of claim 30, wherein the toughness (K1c) is within a range between about 7.75 MPam^{1/2} and about 12 MPam^{1/2} as measured according to an indentation fracture method using a 10 Kg load.

32-33. (canceled)

34. The ceramic material of claim 22, wherein the partially stabilized zirconia body comprises a hardness as measured using the Vickers indentation under a 10 Kg load in accordance with ASTM C1327 of at least about 10 GPa.

35-36. (canceled)

37. The ceramic material of claim 22, wherein the partially stabilized zirconia body comprises a flexure strength of at least about 800 MPa as measured according to ASTM C1161.

38-41. (canceled)

42. The ceramic material of claim 22, wherein the ceramic body is essentially free of magnesia.

43-47. (canceled)

48. The ceramic comprising:
a ceramic body comprising a yttria-stabilized zirconia material having a flexure strength of at least about 800 MPa as measured according to ASTM C1161 and a toughness (K1c) of not less than about 5.5 MPam^{1/2} as measured according to an indentation fracture method using a 10 Kg load.

49-50. (canceled)

51. The ceramic material of claim 48, wherein the ceramic body comprises a flexure strength of at least about 1000 MPa.

52-63. (canceled)
